(19) United States
(12) Patent Application Publication
(10) Pub. No.: US 2026/0262086 A1
(43) Pub. Date: Sep. 3, 2026

(54) DEVICES, METHODS, APPARATUSES AND MEDIA FOR ENABLEMENT OF NON-PRIMARY CHANNEL ACCESS AND COORDINATED SPATIAL REUSE

(71) Applicant: Nokia Technologies Oy, Espoo (FI)

(72) Inventors: Salvatore TALARICO, Sunnyvale, CA (US); Prabodh VARSHNEY, Dallas, TX (US); Klaus Franz DOPPLER, Sunnyvale, CA (US); Mika KASSLIN, Espoo (FI)

(21) Appl. No.: 19/067,121

(22) Filed: Feb. 28, 2025

(51) Int. Cl. H04W 74/0816; H04B 17/318; H04W 52/36

(52) U.S. Cl. CPC H04W 74/0816; H04B 17/318; H04W 52/367

(57) ABSTRACT

Embodiments of the present disclosure relate to devices, methods, apparatuses and medium for enablement of a non-primary channel access (NPCA) scheme and a coordinated spatial reuse (C-SR) scheme. In an aspect, a first device detects an overlapping basic service set (OBSS) transmission of a second device, the OBSS transmission of the second device utilizes a frequency resource substantially overlapping with a primary channel of the first device. The first device determines to enable a NPCA scheme or a coordinated spatial reuse (C-SR) scheme based on detection of the OBSS transmission of the second device, wherein the first device switches to use a NPCA primary channel instead of the primary channel under the NPCA scheme, and the first device reduces a transmitting power under the C-SR scheme. By implementing embodiments of the present disclosure, rules for not enabling the NPCA scheme and the C-SR scheme at the same time are defined.

### FIELD

Various example embodiments generally relate to the field of communication, and in particular, to devices, methods, apparatuses and computer readable storage media related to enablement of a non-primary channel access (NPCA) scheme and a coordinated spatial reuse (C-SR) scheme.

### BACKGROUND

A communication network can be seen as a facility that enables communications between two or more communication devices, or provides communication devices access to a data network. A mobile or wireless communication network is one example of a communication network.

Such communication networks operate in accordance with standards, such as those promulgated by 3GPP (Third Generation Partnership Project) or ETSI (European Telecommunications Standards Institute). Examples of such standards include the so-called 5G (5th Generation) standard or other standards promulgated by 3GPP.

### SUMMARY

In general, example embodiments of the present disclosure provide devices, methods, apparatuses and computer readable storage media for communication, for example, for enablement of a non-primary channel access (NPCA) scheme and a coordinated spatial reuse (C-SR) scheme, especially for separate enablement of the NPCA scheme and the C-SR scheme.

In a first aspect, there is provided a first device. The first device may comprise at least one processor; and at least one memory storing instructions that, when executed by the at least one processor, cause the first device at least to: detect an overlapping basic service set (OBSS) transmission of a second device, the OBSS transmission of the second device utilizes a frequency resource substantially overlapping with a primary channel of the first device; and determine to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces transmitting power under the C-SR scheme.

In a second aspect, there is provided a method. The method may comprise: detecting an overlapping basic service set (OBSS) transmission of a second device, the OBSS transmission of the second device utilizes a frequency resource substantially overlapping with a primary channel of the first device; and determining to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces transmitting power under the C-SR scheme.

In a third aspect, there is provided an apparatus. The apparatus may comprise: means for detecting an overlapping basic service set (OBSS) transmission of a second device, the OBSS transmission of the second device utilizes a frequency resource substantially overlapping with a primary channel of the first device; and means for determining to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces transmitting power under the C-SR scheme.

In a fourth aspect, there is provided a non-transitory computer readable medium comprising program instructions for causing an apparatus to perform at least the method according to the second aspect.

In an fifth aspect, there is provided a computer program comprising instructions, which, when executed by an apparatus, cause the apparatus at least to: detect an overlapping basic service set (OBSS) transmission of a second device, the OBSS transmission of the second device utilizes a frequency resource substantially overlapping with a primary channel of the first device; and determine to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces transmitting power under the C-SR scheme.

In a sixth aspect, there is provided a first device. The first device may comprise: a detecting circuitry configured to detect an overlapping basic service set (OBSS) transmission of a second device, the OBSS transmission of the second device utilizes a frequency resource substantially overlapping with a primary channel of the first device; and a determining circuitry configured to determine to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces transmitting power under the C-SR scheme.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of an application scenario in which some example embodiments of the present disclosure may be implemented;

FIG. 2 illustrates an example signaling process for separate enablement of the NPCA scheme and the C-SR scheme by a first device according to some embodiments of the present disclosure;

FIG. 3A illustrates an example diagram of principles of the NPCA scheme according to some embodiments of the present disclosure;

FIG. 3B illustrates an example diagram of principles of the C-SR scheme according to some embodiments of the present disclosure;

FIG. 4 illustrates an example signaling process for joint enablement of the NPCA scheme and the C-SR scheme by a first device according to some embodiments of the present disclosure;

FIG. 5A illustrates an example diagram of enabling both the NPCA scheme and the C-SR scheme across coordinating STAs according to some embodiments of the present disclosure;

FIG. 5B illustrates an example diagram of enabling both the NPCA scheme and the C-SR scheme across coordinating STAs and non-coordinating STAs according to some embodiments of the present disclosure;

FIG. 6 illustrates a flowchart of an example method implemented at a first device in accordance with some embodiments of the present disclosure;

FIG. 7 illustrates a flowchart of an example method implemented at a first device in accordance with some other embodiments of the present disclosure;

FIG. 8 illustrates an example simplified block diagram of a device that is suitable for implementing embodiments of the present disclosure; and

FIG. 9 illustrates an example block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first”, “second”, “third” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as new radio (NR), long term evolution (LTE), LTE-advanced (LTE-A), wideband code division multiple access (WCDMA), high-speed packet access (HSPA), narrow band Internet of things (NB-IoT), wireless local area network (WLAN), and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, the sixth generation (6G) communication protocols, institute of electrical and electronics engineers (IEEE) 802.11 (Wi-Fi) protocol, IEEE 802.16 (WiMAX) protocol, IEEE 802.20 protocol, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a transmit-receive point (TRP), a remote radio unit (RRU), a radio header (RH), a remote radio head (RRH), a relay, a low power node such as a femto, a pico, an Integrated Access and Backhaul (IAB) node, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An JAB node comprises a Mobile Terminal (IAB-MT) part that behaves like a UE toward the parent node, and a DU part of an JAB node behaves like a base station toward the next-hop IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

In a communication technology, the institute of electrical and electronics engineers (IEEE) designs of Wi-Fi stations (STAs) running latency-sensitive applications such as virtual reality, mixed reality and augmented reality (XR). One of the main limitations of the current design of Wi-Fi STAs is its limited reliability and non-deterministic channel access, especially for wideband transmissions. When wideband transmission (or channel bonding) is used, a listen before talk (LBT) procedure is required on each of 20 MHz channels comprising an overall bandwidth used in the transmission. When operating in this mode, one of those 20 MHz channels would be selected as a primary channel, which is used as a reference channel to communicate critical control and management frames, as well as to support legacy STAs, while data frames are transmitted across an entire bandwidth (BW) by bonding the primary 20 MHz channel with all other available 20 MHz channels, which are called secondary channels. For an access point (AP) or a non-AP STA to acquire a transmission opportunity (TXOP) and perform a wideband transmission, it has to first gain access to the primary channel via an enhanced distributed channel access (EDCA) procedure regardless of whether the secondary channels are idle or not, for which the STA will perform a separate check via a point coordination function interframe space (PIFS) clear channel assessment (CCA).

Currently, a STA (including the AP and non-AP STA) is allowed to adjust its transmission bandwidth to 20 MHz, 40 MHz, 80 MHz or 160 MHz based on channel availability, as long as the primary channel is assessed to be idle. However, if the primary channel is assessed to be not idle, the second channels bonded with the primary channel also cannot be used, leaving large chunks of spectrum unused. For example, when a 20 MHz overlapping basic service set (OBSS) transmission (i.e., transmission from neighboring APs/non-AP STAs or any other device utilizing a same frequency carrier) partially or substantially overlaps with a reference primary 20 MHz channel within a reference 160 MHz in-basic service set (In-BSS) transmission (i.e., transmission from a reference AP/non-AP STA), the transmission on the In-BSS must be deferred since the primary channel is busy or occupied. As a result, all channels except for the primary 20 MHz channel (used by the OBSS) sit idle until the primary channel is free again. As can be seen, the primary channel limitation is one of the bottlenecks in terms of system performance and spectrum utilization.

To address the overlaps between adjacent BSSs, which includes the primary channel limitation, the concepts of non-primary channel access (NPCA) and coordinated spatial reuse (C-SR) have been considered. The concept of the NPCA is to temporarily utilize an idle alternative channel as a primary channel, called as a NPCA primary channel, when the BSS's primary channel is occupied by OBSS or other transmissions. On the other hand, the idea of the C-SR is to coordinate among multiple APs and leverage a coordinated power control management at coordinated APs (e.g., a sharing AP or a shared AP) so as to protect each other's schedules and avoid overlapping transmissions negatively impacting each other's reception. However, there may exist some interoperability issues that need to be addressed when the NPCA scheme and the C-SR scheme are enabled together. Currently, there still lacks rules for regulating how to select or enable the NPCA scheme and the C-SR scheme.

In the present disclosure, certain example embodiments provide methods and/or apparatuses for separate enablement of the NPCA scheme and the C-SR scheme. Based on these embodiments of the present disclosure, the first device (e.g., an AP or a non-AP STA) detects an overlapping basic service set (OBSS) transmission of a second device (e.g., a coordinating AP, a non-AP STA associated with a coordinating AP, a non-coordinating AP or a non-AP STA associated with a non-coordinating AP). The OBSS transmission of the second device utilizes a frequency resource substantially overlapping with a primary channel of the first device. The first device determines to enable a non-primary channel access (NPCA) scheme or a coordinated spatial reuse (C-SR) scheme based on detection of the OBSS transmission of the second device. The first device switches to use a NPCA primary channel instead of the primary channel under the NPCA scheme, and the first device reduces transmitting power under the C-SR scheme.

It is understood that the above procedure steps may work together, in a flow of operations as described below, partly together or independently of each other. By implementing these embodiments of the present disclosure, when the first device (e.g., an AP or a non-AP STA) supports both the NPCA scheme and the C-SR scheme, only one scheme is enabled. In other words, rules for not enabling the NPCA scheme or the C-SR scheme at the same time are defined.

Further, some other example embodiments of the present disclosure provide methods and/or apparatuses for joint enablement of the NPCA scheme and the C-SR scheme. Based on these embodiments of the present disclosure, the first device (e.g., an AP or a non-AP STA) detects an overlapping basic service set (OBSS) transmission of a second device (e.g., a coordinating AP, a non-AP STA associated with a coordinating AP, a non-coordinating AP or a non-AP STA associated with a non-coordinating AP). The OBSS transmission of the second device utilizes a frequency resource substantially overlapping with a primary channel of the first device. The first device determines to enable a non-primary channel access (NPCA) scheme and a coordinated spatial reuse (C-SR) scheme based on detection of the OBSS transmission of the second device. The first device switches to use a NPCA primary channel instead of the primary channel under the NPCA scheme, and the first device reduces transmitting power under the C-SR scheme.

It is understood that the above procedure steps may work together, in a flow of operations as described below, partly together or independently of each other. By implementing these embodiments of the present disclosure, when the first device (e.g., an AP or a non-AP STA) supports both the NPCA scheme and the C-SR scheme, the two schemes are both enabled. In other words, it defines rules for enabling the NPCA scheme and the C-SR scheme at the same time.

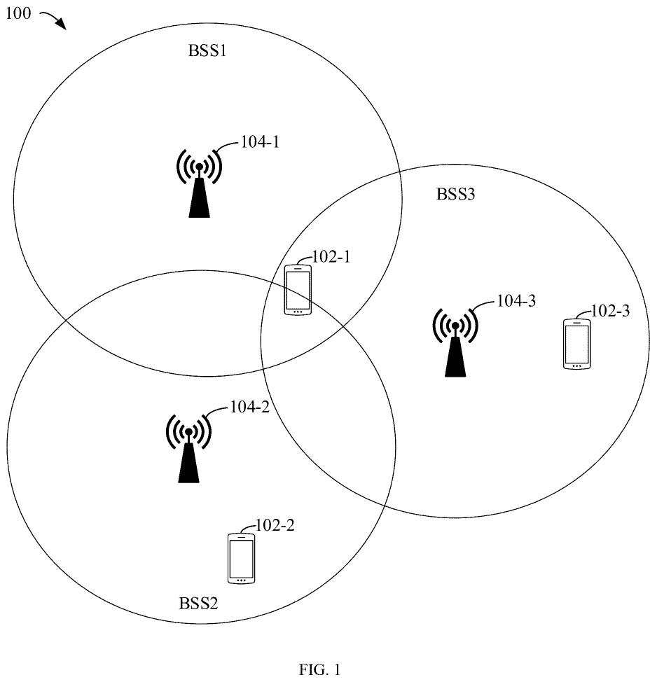

For illustrative purposes, principles and example embodiments of the present disclosure of enablement of a non-primary channel access (NPCA) scheme and a coordinated spatial reuse (C-SR) scheme will be described below with reference to FIG. 1 through FIG. 9. However, it is to be noted that these embodiments are given to enable the skilled in the art to understand inventive concepts of the present disclosure and implement the solution as proposed herein, and not intended to limit scope of the present application in any way.

FIG. 1 illustrates an example of an application scenario 100 in which some example embodiments of the present disclosure may be implemented. The network environment 100, which may be a part of a communication network, comprises a basic service set 1 (BSS1), a BSS2 and a BSS3. The BSS1 comprises an access point (AP) 104-1 and a non-AP STA 102-1. The BSS2 comprises an access point (AP) 104-2 and a non-AP STA 102-2. The BSS3 comprises an access point (AP) 104-3 and a non-AP STA 102-3. The non-AP STA 102-1 may be associated with the AP 104-1, the non-AP STA 102-2 may be associated with the AP 104-2, and the non-AP STA 102-3 may be associated with the AP 104-3. The AP 104-1, the AP 104-2 and the AP 104-3 could be collectively called the AP 104, and the non-AP STA 102-1, the non-AP STA 102-2 and the non-AP STA 102-3 could be collectively called the non-AP STA 102.

As illustrated in FIG. 1, the AP 104 may also be referred to as a TRP 104, and the non-AP STA 102 may also be referred to as a user equipment 102 or a ULE 102. The AP 104 may also be an STA which acts as an AP. The AP 104 can perform uplink/downlink transmission to/from its associated non-AP STA 102. The AP 104-1 may act as a sharing AP and the AP 104-2 may act as a shared AP associated with the AP 104-1. The sharing AP (also called a TXOP holder) refers to an AP which is capable of sharing a TXOP with its associated shared AP (also called a TXOP responder). The sharing AP and its associated shared AP are also called coordinating APs. The AP 104-3 may not act as a sharing AP or a shared AP, which is also called a non-coordinating AP. BSS transmission from the AP 104-2 or the non-AP STA 102-2 may overlap with BSS transmission from the AP 104-1 or the non-AP STA 102-1. In other words, OBSS transmission may occur between coordinating APs or non-AP STA associated with coordinating APs. BSS transmission from the AP 104-3 or the non-AP STA 102-3 may also overlap with BSS transmission from the AP 104-1 or the non-AP STA 102-1. In other words, OBSS transmission may occur between a coordinating AP and a non-coordinating AP or their associated non-AP STAs.

It should be noted that the sharing or shared AP here are just for exemplary purposes, one AP could act not only as a sharing AP, but also could act as a shared AP. Additionally, it is to be understood that the number of devices and their connection relationships and types shown in FIG. 1 are for illustrative purposes only without suggesting any limitation. The communication system 100 may comprise any suitable number of devices adapted for implementing embodiments of the present disclosure.

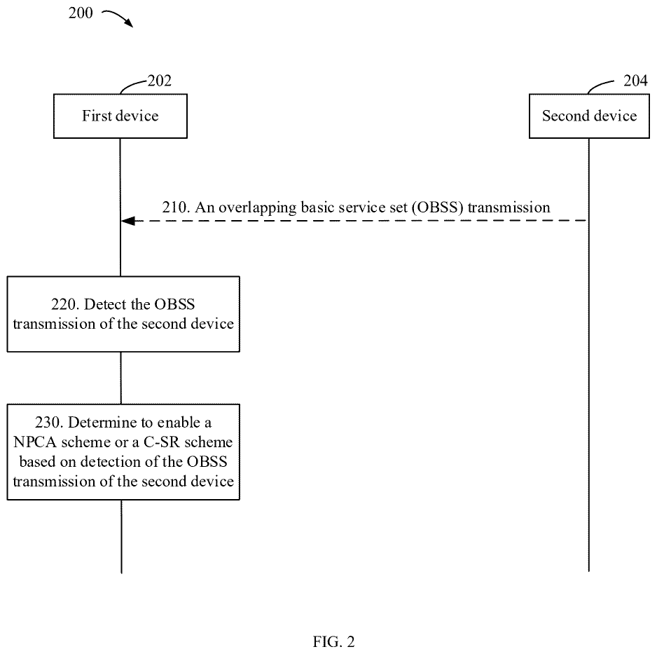

FIG. 2 illustrates an example signaling process 200 for separate enablement of the NPCA scheme and the C-SR scheme by a first device 202 according to some embodiments of the present disclosure. The first device 202 may refer to the AP 104-1 or the non-AP STA 102-1 in FIG. 1.

At 220, the first device 202 may detect an overlapping basic service set (OBSS) transmission of a second device 204. The second device 204 may refer to the AP 104-2, the non-AP STA 102-2, the AP 104-3 or the non-AP STA 102-3 in FIG. 1. The OBSS transmission of the second device 204 utilizes a frequency resource substantially overlapping with a primary channel of the first device 202. Before 220, at 210, the first device 202 may receive an OBSS transmission from the second device 204. At 230, the first device 202 may determine to enable a non-primary channel access (NPCA) scheme or a coordinated spatial reuse (C-SR) scheme based on detection of the OBSS transmission of the second device 204. The first device 202 may switch to use a NPCA primary channel instead of the primary channel under the NPCA scheme. The first device 202 may reduce a transmitting power under the C-SR scheme. In this way, upon detecting the OBSS transmission, the first device 202 will enable only one of the NPCA scheme and the C-SR scheme, thereby defining rules for not enabling the NPCA scheme or the C-SR scheme at the same time. The determination of enabling the NPCA scheme or the C-SR scheme may be performed by an AP or a non-AP STA, i.e., in a distributed manner. Alternatively or additionally, the determination of enabling the NPCA scheme or the C-SR scheme may only be performed by the AP, i.e., in a centralized manner. It is noted that for the NPCA scheme, the first device 202 may switch from the primary channel to the NPCA primary channel triggered by the detection of the OBSS transmission of the second device 204, while for the C-SR scheme, coordinating devices (e.g., including the first device 202 and the second device 204) may agree to participate and enable this feature. The enablement of the C-SR scheme may not be triggered or may not be triggered immediately by the detection of the OBSS transmission of the second device 204.

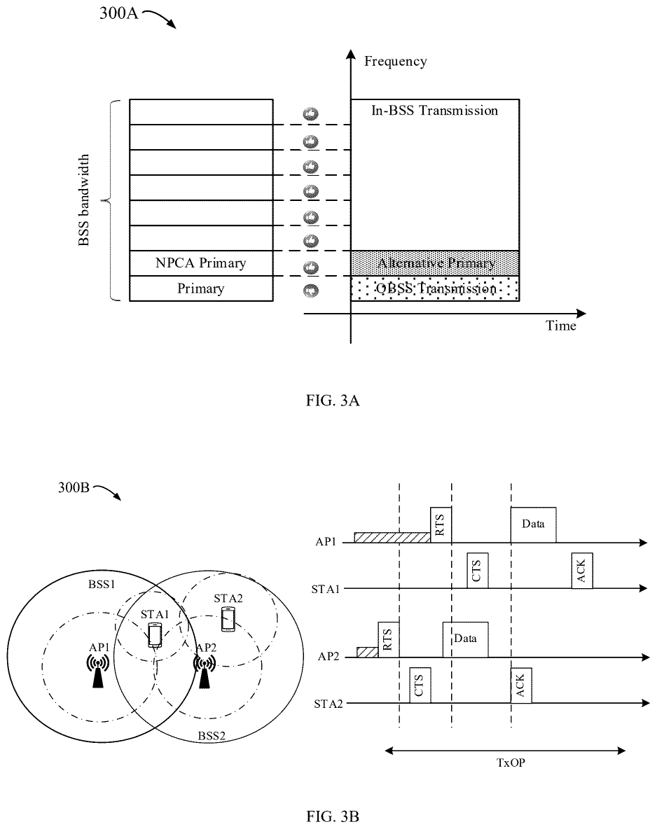

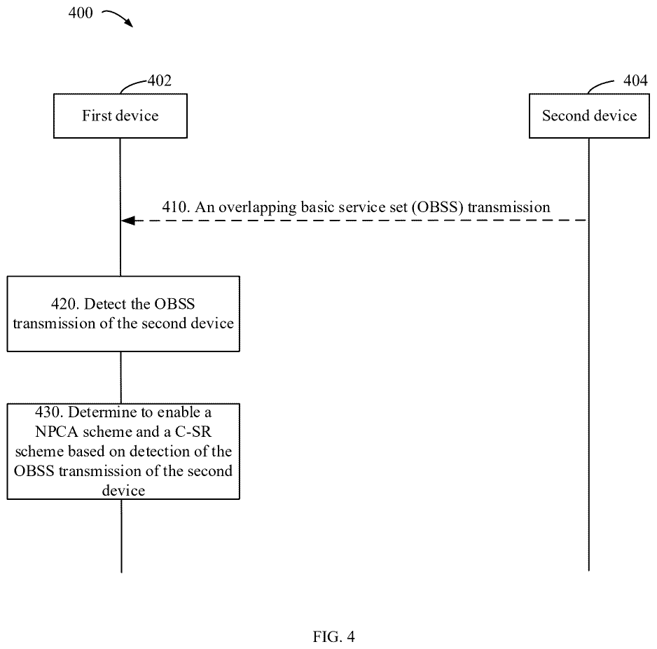

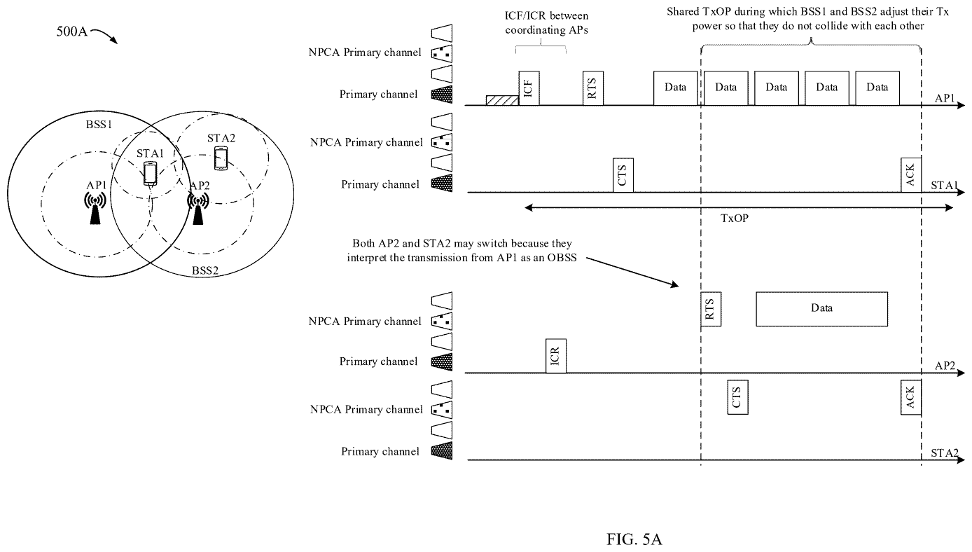

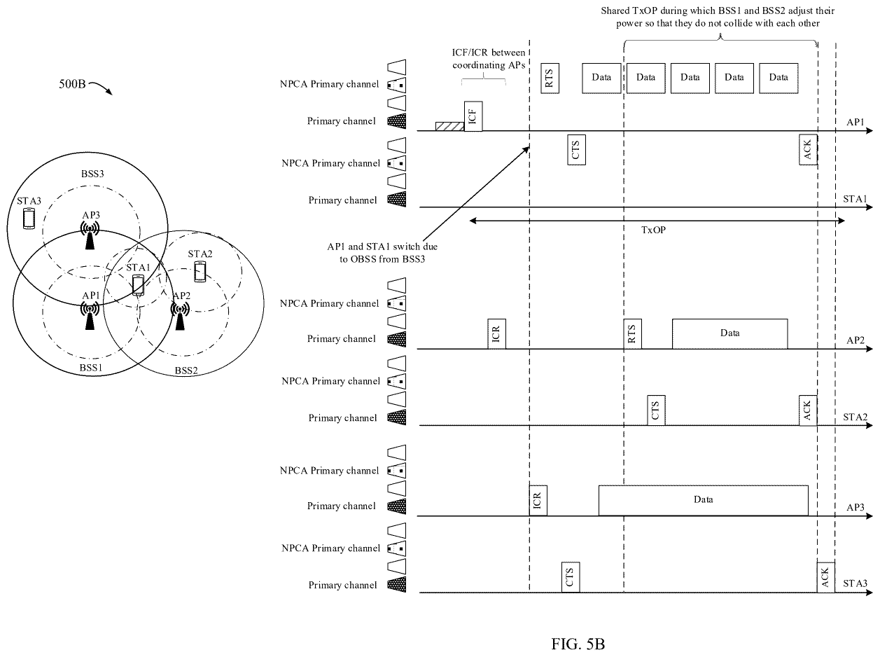

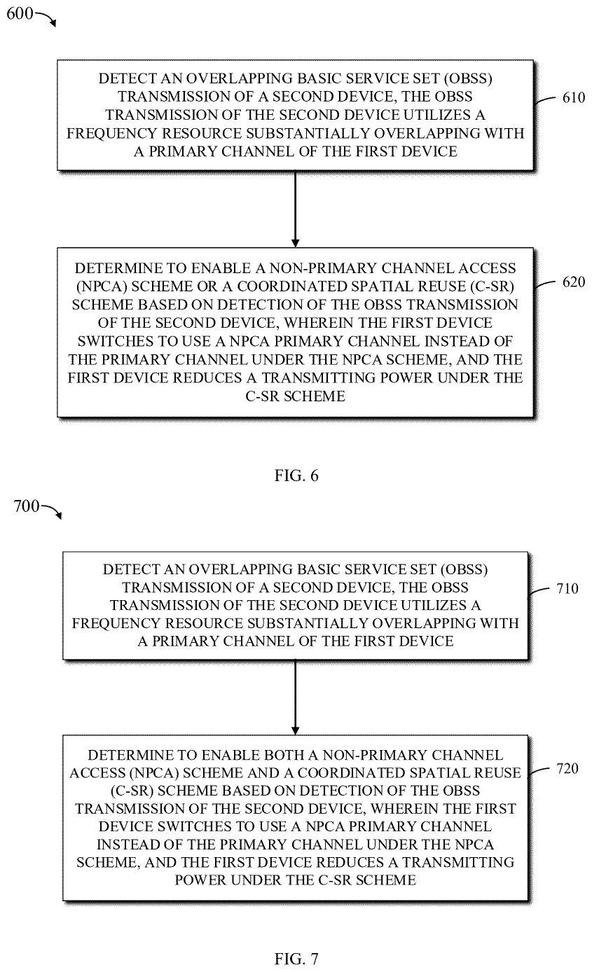

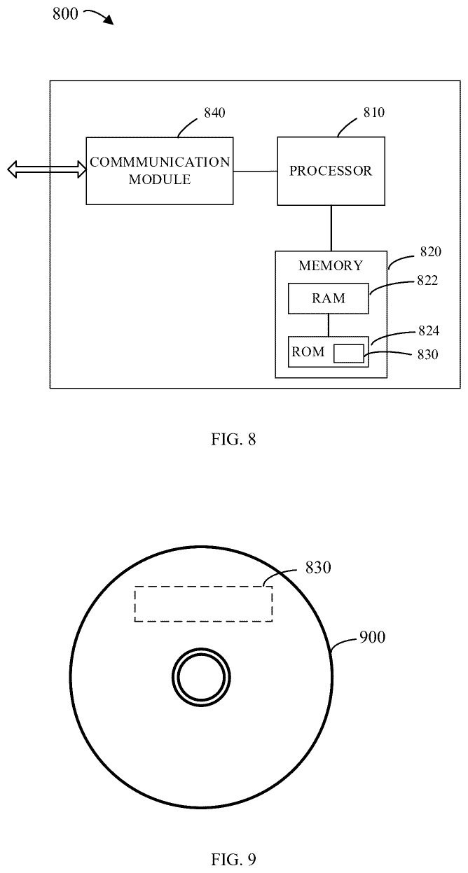

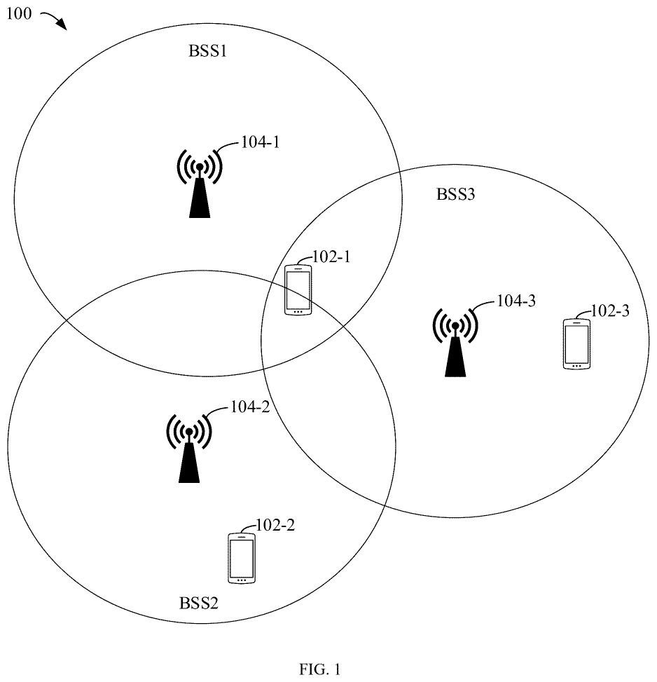

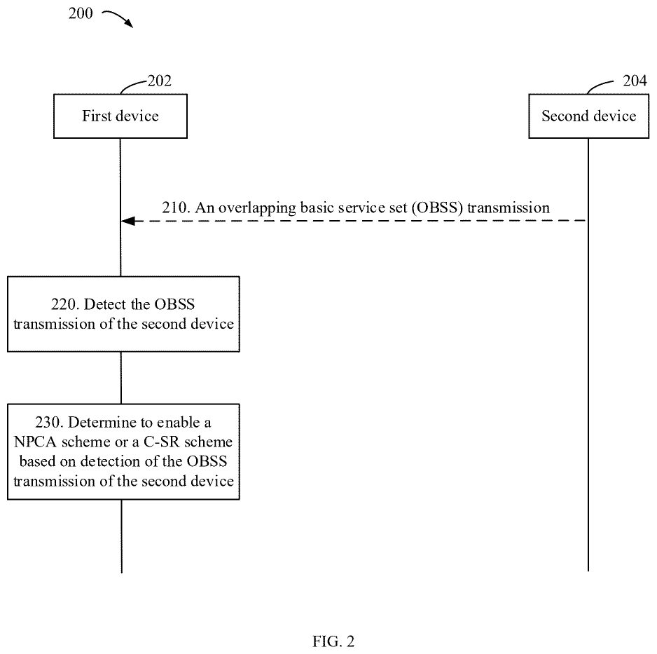

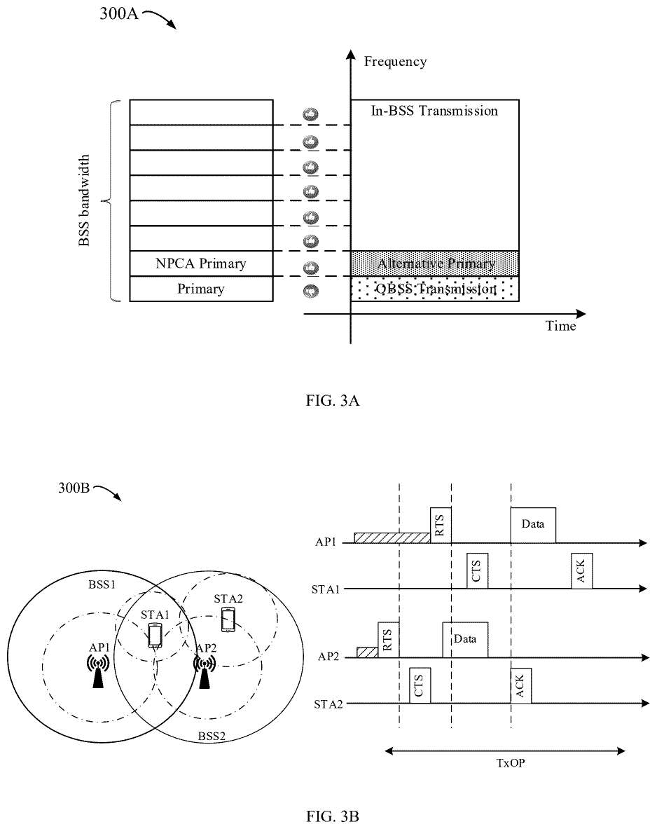

FIG. 3A illustrates an example diagram 300A of principles of the NPCA scheme according to some embodiments of the present disclosure. As illustrated in FIG. 3A, when there is an OBSS transmission on the primary channel of the first device 202, the first device 202 switches to use a NPCA primary channel (also called an alternative primary channel) instead of the primary channel. With the NPCA scheme, the In-BSS transmission would not be deferred when the primary channel is busy, thus all channels except for the primary 20 MHz channel occupied by the BSS will be used normally.

FIG. 3B illustrates an example diagram 300B of principles of the C-SR scheme according to some embodiments of the present disclosure. As illustrated in FIG. 3A, AP2 may share a TXOP with AP1. Through coordination between AP1 and AP2, when there is OBSS transmission between BSS1 and BSS2, the individual transmitting power for each AP (for downlink only transmissions) or for STAs (for both uplink and downlink transmissions) in the two BSSs could be properly selected, so that within the AP2's TXOP the OBSS transmission between the BSS1 and the BSS2 do not cause any mutual interference.

Referring back to FIG. 2, in some example embodiments, the first device 202 supports to enable the NPCA scheme and the C-SR scheme. The second device 204 may also support to enable the NPCA scheme and the C-SR scheme.

In some example embodiments, the first device 202 may determine to enable the NPCA scheme or the C-SR scheme based on a received signal strength indicator (RSSI) of an OBSS physical layer protocol data unit (PPDU) of the second device 204 over the primary channel of the first device 202. For example, the first device 202 may determine to enable the NPCA scheme based on the RSSI of the OBSS PPDU of the second device 204 over the primary channel of the first device 202 being not lower than a first threshold. Alternatively or additionally, the first device 202 may determine to enable the NPCA scheme based on the RSSI of the OBSS PPDU of the second device 204 over the primary channel of the first device 202 being lower than a first threshold. The first threshold may be received from an AP via a beacon message or a probe response message. The first threshold may be a specific threshold τ1, and the first device 202 may determine to enable the NPCA scheme or the C-SR scheme based on the following equation 1:

$$if RSSI \geq τ 1 - β 1 , enable NPCA , else enable C - SR \qquad ( Equation 1 )$$

wherein β1 may be either zero, a positive or negative number. The value of τ1 could be advertised by an AP via a beacon or a probe response. In this way, NPCA will be enabled when the received power of OBSS transmission is greater, which would be more effective than adjusting the transmitting power by using the C-SR scheme. Alternatively or additionally, C-SR scheme will be enabled when the received power of OBSS transmission is lower, a small change in transmitting power would reduce or eliminate the existing interference and mutual blocking between adjacent BSSs, thereby saving the switching time for switching from the primary channel to the NPCA primary channel and switching from the NPCA primary channel back to the primary channel if using the NPCA scheme.

Alternatively or additionally, the first device 202 may determine to enable the NPCA scheme or the C-SR scheme based on a distance between the OBSS transmission of the second device 204 and basic service set (BSS) transmission of the first device 202 or a distance between the first device 202 and the second device 204. For example, the first device 202 may determine to enable the NPCA scheme based on the distance between the OBSS transmission of the second device 204 and BSS transmission of the first device 202 or the distance between the first device 202 and the second device 204 being lower than a second threshold. Alternatively or additionally, the first device 202 may determine to enable the C-SR scheme based on the distance between the OBSS transmission of the second device 204 and BSS transmission of the first device 202 or the distance between the first device 202 and the second device 204 being not lower than a second threshold. The second threshold may be received from an AP via a beacon message or a probe response message. The second threshold may be a specific threshold τ2, and the first device 202 may determine to enable the NPCA scheme or the C-SR scheme based on the following equation 2:

$$if Distance \geq τ 2 - β 2 , enable C - SR , else enable NPCA \qquad ( Equation 2 )$$

wherein β2 may be either zero, a positive or negative number. The value of τ2 could be advertised by an AP via a beacon or a probe response. In this way, NPCA will be enabled when the distance between BSSs is shorter, which would be more effective than adjusting the transmitting power by using the C-SR scheme. Alternatively or additionally, C-SR scheme will be enabled when the distance between BSSs is far, a small change in transmitting power would reduce or eliminate the existing interference and mutual blocking between adjacent BSSs, thereby saving the switching time for switching from the primary channel to the NPCA primary channel and switching from the NPCA primary channel back to the primary channel if using the NPCA scheme.

Alternatively or additionally, the first device 202 may determine to enable the NPCA scheme or the C-SR scheme based on transmitting power of at least one of the first device 202 or the second device 204. For example, the first device 202 may determine to enable the NPCA scheme based on the transmitting power of the first device 202 being not lower than a third threshold. Alternatively or additionally, the first device 202 may determine to enable the C-SR scheme based on transmitting power of the first device 202 being lower than a third threshold. The third threshold may be received from an AP via a beacon message or a probe response message. The third threshold may be a specific threshold τ3, and the first device 202 may determine to enable the NPCA scheme or the C-SR scheme based on the following equation 3:

$$if Tx power \geq τ 3 - β 3 , enable C - SR , else enable NPCA \qquad ( Equation 3 )$$

wherein β3 may be either zero, a positive or negative number. The value of τ3 could be advertised by an AP via a beacon or a probe response. In this way, NPCA will be enabled when the transmitting power of BSSs is larger, which would be more effective than adjusting the transmitting power by using the C-SR scheme. Alternatively or additionally, C-SR scheme will be enabled when the transmitting power of BSSs is smaller, a small change in transmitting power would reduce or eliminate the existing interference and mutual blocking between adjacent BSSs, thereby saving the switching time for switching from the primary channel to the NPCA primary channel and switching from the NPCA primary channel back to the primary channel if using the NPCA scheme.

It is noted that the above embodiments regarding the received RSSI, the distance between BSSs transmission or BSSs, and transmitting power may be implemented in a separate and/or mixed manner. In other words, the first device 202 may determine to enable the NPCA scheme or the C-SR scheme based on at least one of: the received RSSI of the OBSS PPDU of the second device 204 over the primary channel of the first device 202; the distance between the OBSS transmission of the second device 204 and the BSS transmission of the first device 202 or a distance between the first device 202 and the second device; or the transmitting power of at least one of the first device 202 or the second device 204.

In some example embodiments, the first device 202 may act as a sharing AP or a non-AP STA associated with a sharing AP, and the second device 204 may act as a shared AP or a non-AP STA associated with a shared AP. Alternatively or additionally, the first device 202 may act as shared AP or a non-AP STA associated with a shared AP, and the second device 204 may act as sharing AP or a non-AP STA associated with a sharing AP. The sharing AP is capable of sharing a transmission opportunity (TXOP) with the shared AP.

In some example embodiments, the first device 202 may act as an AP, and the NPCA scheme is enabled at a non-AP STA associated with the first device 202 when the first device 202 determines to enable the NPCA scheme. In other words, if an AP decides to enable the NPCA scheme, it is necessary that the associated non-AP STA has NPCA enabled.

Alternatively or additionally, the first device 202 may act as a non-AP STA associated with an AP, and the NPCA scheme is enabled at the AP associated with the first device 202 when the first device 202 determines to enable the NPCA scheme. In other words, if a non-AP STA decides to enable the NPCA scheme, it is necessary that the associated AP has NPCA enabled.

In some example embodiments, the C-SR scheme is disabled at the first device 202 and the second device 204 when the first device 202 or the second device 204 determines to enable the NPCA scheme. The first device 202 and the second device 204 may be coordinating APs or non-AP STAs associated with coordinating APs. That is to say, when one of the coordinating APs (either the sharing or shared AP) has NPCA enabled, then C-SR is disabled at both coordinating APs.

By implementing these embodiments described with reference to FIG. 2, FIG. 3A and FIG. 3B, when the first device 202 (e.g., an AP or a non-AP STA) supports both the NPCA scheme and the C-SR scheme, only one scheme is enabled. In other words, these embodiments define rules for not enabling the NPCA scheme or the C-SR scheme at the same time. Further, these embodiments also define rules for enabling the NPCA scheme or the C-SR scheme based on the RSSI, the distance between BSSs or the transmitting power, thereby solving the primary channel limitation more effectively and improving interoperability between the NPCA scheme and the C-SR scheme.

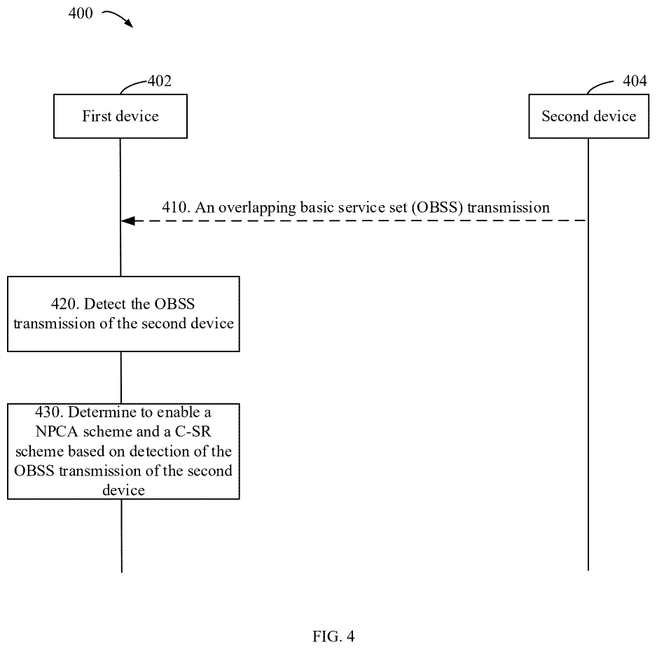

FIG. 4 illustrates an example signaling process 400 for joint enablement of the NPCA scheme and the C-SR scheme by a first device 402 according to some embodiments of the present disclosure. The first device 402 may refer to the AP 104-1 or the non-AP STA 102-1 in FIG. 1.

At 420, the first device 402 may detect an overlapping basic service set (OBSS) transmission of a second device 404. The second device 404 may refer to the AP 104-2, the non-AP STA 102-2, the AP 104-3 or the non-AP STA 102-3 in FIG. 1. The OBSS transmission of the second device 404 utilizes a frequency resource substantially overlapping with a primary channel of the first device 402. Before 420, at 410, the first device 402 may receive an OBSS transmission from the second device 404. At 430, the first device 402 may determine to enable a non-primary channel access (NPCA) scheme and a coordinated spatial reuse (C-SR) scheme based on detection of the OBSS transmission of the second device 404. The first device 402 may switch to use a NPCA primary channel instead of the primary channel under the NPCA scheme. The first device 402 may reduce a transmitting power under the C-SR scheme. In this way, upon detecting the OBSS transmission, the first device 402 will enable both the NPCA scheme and the C-SR scheme, thereby defining rules for enabling the NPCA scheme and the C-SR scheme at the same time. The determination of enabling the NPCA scheme and the C-SR scheme may be performed by an AP or a non-AP STA, i.e., in a distributed manner. Alternatively or additionally, the determination of enabling the NPCA scheme and the C-SR scheme may only be performed by the AP, i.e., in a centralized manner.

In some example embodiments, the first device 402 may act as a shared AP or a non-AP station (STA) associated with a shared AP. The C-SR scheme is enabled but the NPCA scheme is disabled at a sharing AP or a non-AP STA associated with a sharing AP. The sharing AP is capable of sharing a transmission opportunity (TXOP) with the shared AP. In such embodiments, when a shared or sharing AP and its associated non-AP STAs are capable of both the NPCA scheme and the C-SR scheme, the sharing AP shall only enable the C-SR scheme, but the shared AP may jointly enable both the NPCA scheme and the C-SR scheme. In other words, when the C-SR scheme is enabled, the NPCA switching is allowed only at the shared AP and its associated non-AP STAs. For example, when a non-AP STA associated with a sharing AP has NPCA enabled, and it detects through an initial control frame (ICF) or through other methods that its associated AP is sharing a TXOP with another AP, it shall operate as if NPCA is disabled.

In some example embodiments, the first device 402 may act as a sharing AP. In response to switching to use the NPCA primary channel before transmitting an initial control frame (ICF), the first device 402 may share a portion of a transmission opportunity (TXOP) with a shared AP based on at least one of the following is satisfied: a basic network allocation vector (NAV) of the OBSS transmission being longer than a first threshold; or the portion of the TXOP is a time frame during which a basic network allocation vector (NAV) of the OBSS transmission does not expire. The first device 402 is capable of the NPCA scheme and the C-SR scheme. The first threshold may be fixed or configurable.

In some example embodiments, the first device 402 may reduce the transmitting power for a portion of a TXOP based on the first device 402 switching to use the NPCA primary channel. In such embodiments, when a shared and/or sharing AP and its associated non-AP STAs are capable of both NPCA and C-SR, and both schemes are enabled in both BSSs, if NPCA switching occurs, then a STA (either an AP or a non-AP STA involved in the switching) will not apply power levels or power management as intended for C-SR for the entire sharing AP's TXOP. However, once the STA switches back to the primary channel, it may again be subject to the transmit power constraints or transmit power levels negotiated by the sharing and/or shared APs and its associated non-AP STAs.

Alternatively or additionally, the first device 402 may reduce the transmitting power after the first device 402 switching back to use the primary channel from the NPCA primary channel. In such embodiments, when a shared and/or sharing AP and its associated non-AP STAs are capable of both NPCA and C-SR, and both schemes are enabled in both BSSs, if NPCA switching occurs, then a STA (either an AP or a non-AP STA involved in the switching) will not apply power levels or power management as intended for C-SR until switching back to the primary channel. However, once the STA switches back to the primary channel, it may again be subject to the transmit power constraints or transmit power levels negotiated by the sharing and/or shared APs and its associated non-AP STAs.

Alternatively or additionally, the first device 402 may reduce the transmitting power for a whole TXOP based on the first device 402 switching to use the NPCA primary channel.

In such embodiments, when a shared and/or sharing AP and its associated non-AP STAs are capable of both NPCA and C-SR, and both schemes are enabled in both BSSs, if NPCA switching occurs, then a STA (either an AP or a non-AP STA involved in the switching) will still apply power levels and power management as intended for C-SR for the entire sharing AP's TXOP.

In some example embodiments, the first device 402 may switch to use the NPCA primary channel based on receiving an OBSS transmission with a received power level higher than a second threshold. Alternatively or additionally, the first device 402 may switch to use the NPCA primary channel based on receiving an OBSS transmission with a received power level higher than a second threshold and information indicating the OBSS transmission is from a non-coordinating AP or a non-AP STA associated with a non-coordinating AP, wherein the non-coordinating AP is an AP which does not act as a sharing AP or a shared AP. The OBSS transmission may comprise transmission of at least one of the following: an OBSS control frame, an OBSS high efficiency (HE) physical layer protocol data unit (PPDU), an OBSS extremely high throughput (EHT) PPDU, an OBSS ultra high reliability (UHR) PPDU. The information indicating the OBSS transmission is from a non-coordinating AP may comprise at least one of the following: a BSS color associated with the non-coordinating AP, a BSSID associated with the non-coordinating AP, or an AP ID associated with the non-coordinating AP. In some example embodiments, the second threshold may be a common OBSS packet detection (PD) threshold. The common OBSS PD threshold may be obtained by negotiation between a sharing AP and at least one shared AP, selection of an AP, and/or selection of a non-AP STA based on guidance from an AP associated with the non-AP STA. For example, the AP may provide some minimum and maximum values among which the non-AP STA can select. Specifically, when a shared and sharing AP and its associated non-AP STAs are capable of both NPCA and C-SR, and when NPCA and C-SR are both enabled at the shared and sharing APs, a STA in either BSSs with both features enabled may switch to an NPCA primary channel according to one of the following options:
Option 1: An NPCA-capable STA using OBSS packet detection (PD)-based SR receives an OBSS control frame or an OBSS HE/EHT/UHR PPDU that overlaps the primary channel with a received power level higher than the legacy threshold (−82 dBm).
Option 2: An NPCA-capable STA using OBSS PD-based SR receives an OBSS control frame or an OBSS HE/EHT/UHR PPDU that overlaps the primary channel with a received power level higher than the legacy threshold (−82 dBm) and with BSS color or BSSID/AP ID, or any other information that could be used to identify that a transmission is not originated by any other coordinating AP(s).
Option 3: An NPCA-capable STA using OBSS PD-based SR receives an OBSS control frame or an OBSS HE/EHT/UHR PPDU that overlaps the primary channel with a power level higher than a specific threshold called here common OBSS PD.
Option 4: An NPCA-capable STA using OBSS PD-based SR receives an OBSS control frame or an OBSS HE/EHT/UHR PPDU that overlaps the primary channel with a power level higher than a specific threshold called here common OBSS PD and with BSS color or BSSID/AP ID, or any other information that could be used to identify that a transmission is not originated by any other coordinating AP(s).

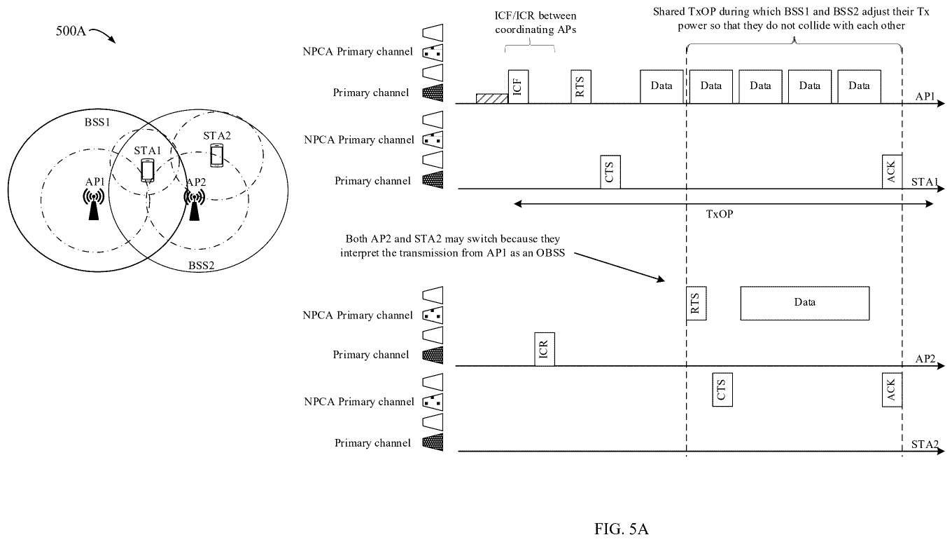

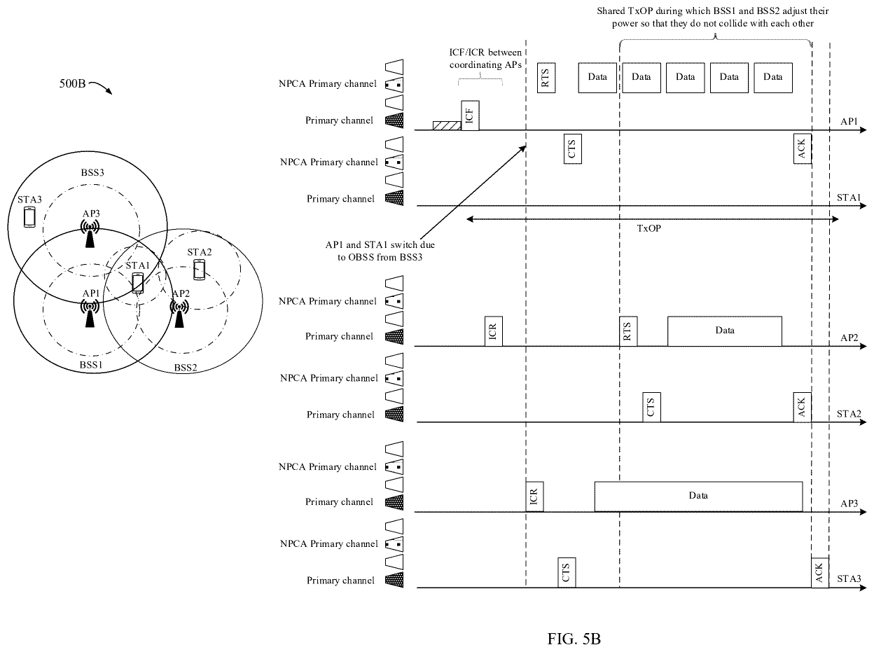

FIG. 5A illustrates an example diagram 500A of enabling both the NPCA scheme and the C-SR scheme across coordinating STAs (e.g., coordinating APs or non-AP STAs associated with coordinating APs) according to some embodiments of the present disclosure. As illustrated by FIG. 5A, AP1 and AP2 are coordinating APs. During the shared TXOP, BSS1 and BSS2 may adjust their transmitting power so as not to collide with each other. The BSS2 may switch to the NPCA primary channel when it interprets the transmission from AP1 as an OBSS transmission.

FIG. 5B illustrates an example diagram 500B of enabling both the NPCA scheme and the C-SR scheme across coordinating STAs (e.g., coordinating APs or non-AP STAs associated with coordinating APs) and non-coordinating STAs (e.g., non-coordinating APs or non-AP STAs associated with non-coordinating APs) according to some embodiments of the present disclosure. As illustrated by FIG. 5B, AP1 and AP2 are coordinating APs and AP3 is a non-coordinating AP. During the shared TXOP, BSS1 and BSS2 may adjust their transmitting power so as not to collide with each other. The BSS1 may switch to the NPCA primary channel when it interprets the transmission from AP3 as an OBSS transmission.

Referring back to FIG. 4, in some example embodiments, the first device 402 may act as a shared AP or a non-AP station (STA) associated with a shared AP, and the second device 404 may act as sharing AP or a non-AP STA associated with a sharing AP, the sharing AP is capable of sharing a transmission opportunity (TXOP) with the shared AP, the first device 402 does not switch to use the NPCA primary channel based on detection of the OBSS transmission of the second device 404. In such embodiments, when a shared AP and its associated non-AP STAs are capable of both NPCA and C-SR, and when C-SR is enabled among coordinating APs, if NPCA is enabled at the shared AP, switching is not done if the OBSS detected is from the sharing AP (or other shared APs). In some example embodiments, the message is one of an ICF, a beacon frame, an association frame, or a probe frame. The information indicating the OBSS transmission is from the second device 404 comprises at least one of the following: a BSS color associated with the second device 404, a BSSID associated with the second device 404, or an AP ID associated with the second device 404. In such embodiments, the BSS color or BSSID/AP ID, or any other information that could be used by the shared AP and its associated non-AP STAs to identify the transmissions from coordinated APs and its associated non-AP STAs could be included in the ICF sent by the sharing AP. As an example, the BSS color or BSSID/AP ID, or any other information that could be used by the shared AP and its associated non-AP STAs to identify the transmissions from coordinated APs and its associated non-AP STAs could be shared among APs during negotiation and broadcasted via beacon frames, or other management frames (e.g., association or probe frames).

In some example embodiments, the first device 402 may act as shared AP or a non-AP station (STA) associated with a shared AP. After switching to the NPCA primary channel, the first device 402 may keep using the NPCA primary channel until an end of a sharing AP's TXOP subtracting switching time for switching from the NPCA primary channel back to the primary channel. The sharing AP is capable of sharing a TXOP with the first device 402. In such embodiments, when a shared (or sharing) AP and its associated non-AP STAs are capable of both NPCA and C-SR, and when NPCA and C-SR are both enabled at the shared and sharing APs, a STA belonging to the shared BSS may remain on the NPCA primary channel when switching has occurred until the end of the sharing AP's TXOP minus a component which may depend on the device's switching time. The switching time may be maximum switching time across all STAs or switching time of the AP.

In some example embodiments, the first device 402 may switch back to use the primary channel from the NPCA primary channel based on switch back time. The switch back time may be determined based on basic NAV or a maximum value between the basic NAV and intra-BSS NAVs. As one option, the basic NAV may be related to any OBSS transmission detected by the first device 402 and being from any coordinating and non-coordinating APs and non-AP STAs associated with coordinating and non-coordinating APs, wherein the coordinating AP is an AP acting as a sharing AP or a shared AP. Alternatively or additionally, the basic NAV may be related to an OBSS transmission detected by the first device 402 and being from any non-coordinating APs and non-AP STAs associated with non-coordinating APs, wherein the non-coordinating AP is an AP which does not act as a sharing AP or a shared AP.

By implementing these embodiments described with reference to FIG. 4, FIG. 5A and FIG. 5B, when the first device 402 (e.g., an AP or a non-AP STA) supports both the NPCA scheme and the C-SR scheme, two schemes could be jointly enabled. In other words, these embodiments define rules for enabling the NPCA scheme and the C-SR scheme at the same time. Further, these embodiments also define specific rules for enabling the NPCA scheme and the C-SR scheme, thereby solving the primary channel limitation more effectively and improving interoperability between the NPCA scheme and the C-SR scheme.

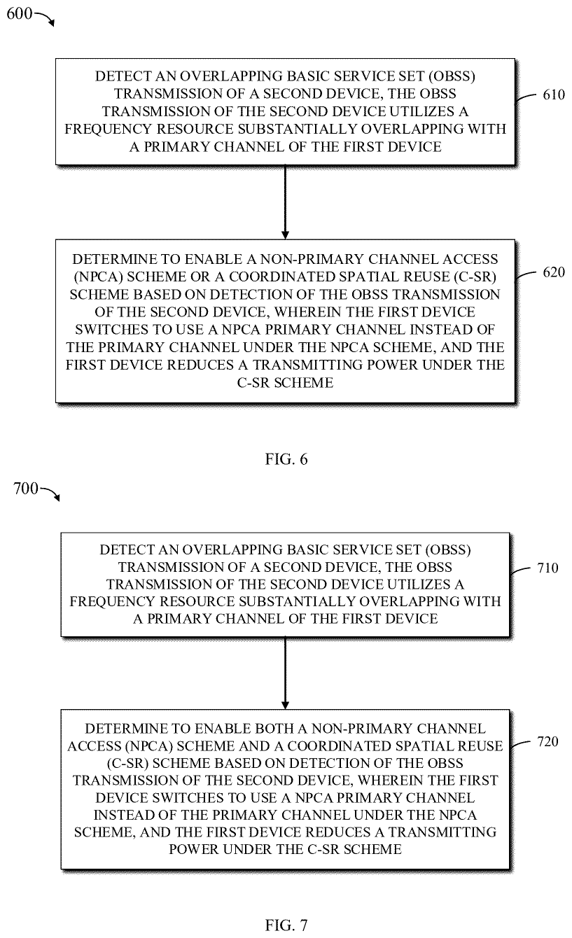

FIG. 6 illustrates a flowchart of an example method 600 implemented at a first device (for example, an AP 104, a non-AP STA 102, or a first device 202) in accordance with some embodiments of the present disclosure. For ease of understanding, the method 600 will be described from the perspective of the first device 202 with reference to FIG. 2.

At block 610, the first device 202 detects an overlapping basic service set (OBSS) transmission of a second device, the OBSS transmission of the second device utilizes a frequency resource substantially overlapping with a primary channel of the first device 202. At block 620, the first device 202 determines to enable a non-primary channel access (NPCA) scheme or a coordinated spatial reuse (C-SR) scheme based on detection of the OBSS transmission of the second device, wherein the first device 202 switches to use a NPCA primary channel instead of the primary channel under the NPCA scheme, and the first device 202 reduces a transmitting power under the C-SR scheme.

In some example embodiments, the first device 202 supports to enable the NPCA scheme and the C-SR scheme.

In some example embodiments, the first device 202 is caused to determine to enable the NPCA scheme or the C-SR scheme based on at least one of the following: a received signal strength indicator (RSSI) of an OBSS physical layer protocol data unit (PPDU) of the second device over the primary channel of the first device 202; a distance between the OBSS transmission of the second device and basic service set (BSS) transmission of the first device 202 or a distance between the first device 202 and the second device; or transmitting power of at least one of the first device 202 or the second device.

In some example embodiments, the first device 202 is caused to determine to enable the NPCA scheme or the C-SR scheme by: determining to enable the NPCA scheme based on the RSSI of the OBSS PPDU of the second device over the primary channel of the first device 202 being not lower than a first threshold; or determining to enable the C-SR scheme based on the RSSI of the OBSS PPDU of the second device over the primary channel of the first device 202 being lower than a first threshold.

In some example embodiments, the first device 202 is caused to determine to enable the NPCA scheme or the C-SR scheme by: determining to enable the NPCA scheme based on the distance between the OBSS transmission of the second device and BSS transmission of the first device 202 or the distance between the first device 202 and the second device being lower than a second threshold; or determining to enable the C-SR scheme based on the distance between the OBSS transmission of the second device and BSS transmission of the first device 202 or the distance between the first device 202 and the second device being not lower than a second threshold.

In some example embodiments, the first device 202 is caused to determine to enable the NPCA scheme or the C-SR scheme by: determining to enable the NPCA scheme based on the transmitting power of the first device 202 being not lower than a third threshold; or determining to enable the C-SR scheme based on transmitting power of the first device 202 being lower than a third threshold.

In some example embodiments, at least one of a first threshold, a second threshold or a third threshold is received from an access point (AP) via a beacon message or a probe response message.

In some example embodiments, one of the following is satisfied: the first device 202 acts as a sharing AP or a non-AP station (STA) associated with a sharing AP, and the second device acts as a shared AP or a non-AP STA associated with a shared AP; or the first device 202 acts as shared AP or a non-AP station (STA) associated with a shared AP, and the second device acts as sharing AP or a non-AP STA associated with a sharing AP, wherein the sharing AP is capable of sharing a transmission opportunity (TXOP) with the shared AP.

In some example embodiments, one of the following is satisfied: the first device 202 acts as an AP, and the NPCA scheme is enabled at a non-AP STA associated with the first device 202 when the first device 202 determines to enable the NPCA scheme; or the first device 202 acts as a non-AP STA associated with an AP, and the NPCA scheme is enabled at the AP associated with the first device 202 when the first device 202 determines to enable the NPCA scheme.

In some example embodiments, the C-SR scheme is disabled at the first device 202 and the second device when the first device 202 or the second device determines to enable the NPCA scheme.

FIG. 7 illustrates a flowchart of an example method 700 implemented at a first device (for example, an AP 104, a non-AP STA 102, or a first device 402) in accordance with some embodiments of the present disclosure. For ease of understanding, the method 700 will be described from the perspective of the first device 402 with reference to FIG. 4.

At block 710, the first device 402 detects an overlapping basic service set (OBSS) transmission of a second device, the OBSS transmission of the second device utilizes a frequency resource substantially overlapping with a primary channel of the first device 402. At block 720, the first device 402 determines to enable both a non-primary channel access (NPCA) scheme and a coordinated spatial reuse (C-SR) scheme based on detection of the OBSS transmission of the second device, wherein the first device 402 switches to use a NPCA primary channel instead of the primary channel under the NPCA scheme, and the first device 402 reduces a transmitting power under the C-SR scheme.

In some example embodiments, the first device 402 acts as a shared AP or a non-AP station (STA) associated with a shared AP, the C-SR scheme is enabled but the NPCA scheme is disabled at a sharing AP or a non-AP STA associated with a sharing AP, the sharing AP is capable of sharing a transmission opportunity (TXOP) with the shared AP.

In some example embodiments, the first device 402 acts as a sharing AP, the first device 402 is further caused to: in response to switching to use the NPCA primary channel before transmitting an initial control frame (ICF), share a portion of a transmission opportunity (TXOP) with a shared AP based on at least one of the following is satisfied: a basic network allocation vector (NAV) of the OBSS transmission being longer than a first threshold; or the portion of the TXOP is a time frame during which a basic network allocation vector (NAV) of the OBSS transmission does not expire.

In some example embodiments, the first device 402 is further caused to: reduce the transmitting power for a portion of a TXOP or a whole TXOP based on the first device 402 switching to use the NPCA primary channel.

In some example embodiments, the first device 402 is further caused to: reduce the transmitting power after the first device 402 switching back to use the primary channel from the NPCA primary channel.

In some example embodiments, the first device 402 is further caused to switch to use the NPCA primary channel based on at least one of the following: receiving an OBSS transmission with a received power level higher than a second threshold; or receiving an OBSS transmission with a received power level higher than a second threshold and information indicating the OBSS transmission is from a non-coordinating AP or a non-AP STA associated with a non-coordinating AP, wherein the non-coordinating AP is an AP which does not act as a sharing AP or a shared AP.

In some example embodiments, at least one of the following is satisfied: the second threshold is a common OBSS packet detection (PD) threshold; the information indicating the OBSS transmission is from a non-coordinating AP comprises at least one of the following: a BSS color associated with the non-coordinating AP, a BSSID associated with the non-coordinating AP, or an AP ID associated with the non-coordinating AP; or the OBSS transmission comprises transmission of at least one of the following: an OBSS control frame, an OBSS high efficiency (HE) physical layer protocol data unit (PPDU), an OBSS extremely high throughput (EHT) PPDU, an OBSS ultra high reliability (UHR) PPDU.

In some example embodiments, the common OBSS PD threshold is obtained by at least one of the following: negotiation between a sharing AP and at least one shared AP; selection of an AP; or selection of a non-AP STA based on guidance from an AP associated with the non-AP STA.

In some example embodiments, the first device 402 acts as a shared AP or a non-AP station (STA) associated with a shared AP, and the second device acts as sharing AP or a non-AP STA associated with a sharing AP, the sharing AP is capable of sharing a transmission opportunity (TXOP) with the shared AP, the first device 402 does not switch to use the NPCA primary channel based on detection of the OBSS transmission of the second device.

In some example embodiments, the first device 402 is further caused to: receive, from the second device, a message comprising information indicating the OBSS transmission is from the second device.

In some example embodiments, the message is one of an ICF, a beacon frame, an association frame, or a probe frame; and the information indicating the OBSS transmission is from the second device comprises at least one of the following: a BSS color associated with the second device, a BSSID associated with the second device, or an AP ID associated with the second device

In some example embodiments, the first device 402 acts as shared AP or a non-AP station (STA) associated with a shared AP, the first device 402 is further caused to: after switching to the NPCA primary channel, keep using the NPCA primary channel until an end of a sharing AP's TXOP subtracting switching time for switching from the NPCA primary channel back to the primary channel, wherein the sharing AP is capable of sharing a TXOP with the first device 402.

In some example embodiments, the first device 402 is further caused to: switch back to use the primary channel from the NPCA primary channel based on switch back time, wherein the switch back time is determined based on basic NAV or a maximum value between the basic NAV and intra-BSS NAVs.

In some example embodiments, the basic NAV is related to at least one of the following: any OBSS transmission detected by the first device 402 and being from any coordinating and non-coordinating APs and non-AP STAs associated with coordinating and non-coordinating APs, wherein the coordinating AP is an AP acting as a sharing AP or a shared AP; or an OBSS transmission detected by the first device 402 and being from any non-coordinating APs and non-AP STAs associated with non-coordinating APs, wherein the non-coordinating AP is an AP which does not act as a sharing AP or a shared AP.

In some example embodiments, an apparatus (for example, the first device 202) capable of performing the method 600 may comprise means for performing the respective steps of the method 600. The means may be implemented in any suitable form. For example, the means may be implemented in a circuitry or software module.

In some example embodiments, the apparatus may comprise: means for detecting, by a first device, an overlapping basic service set (OBSS) transmission of a second device, the OBSS transmission of the second device utilizes a frequency resource substantially overlapping with a primary channel of the first device; and means for determining, by the first device, to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces a transmitting power under the C-SR scheme.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some example embodiments, an apparatus (for example, the first device 402) capable of performing the method 700 may comprise means for performing the respective steps of the method 700. The means may be implemented in any suitable form. For example, the means may be implemented in a circuitry or software module.

In some example embodiments, the apparatus may comprise: means for detecting, by a first device, an overlapping basic service set (OBSS) transmission of a second device, the OBSS transmission of the second device utilizes a frequency resource substantially overlapping with a primary channel of the first device; and means for determining, by the first device, to enable both a non-primary channel access (NPCA) scheme and a coordinated spatial reuse (C-SR) scheme based on detection of the OBSS transmission of the second device, wherein the first device switches to use a NPCA primary channel instead of the primary channel under the NPCA scheme, and the first device reduces a transmitting power under the C-SR scheme.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

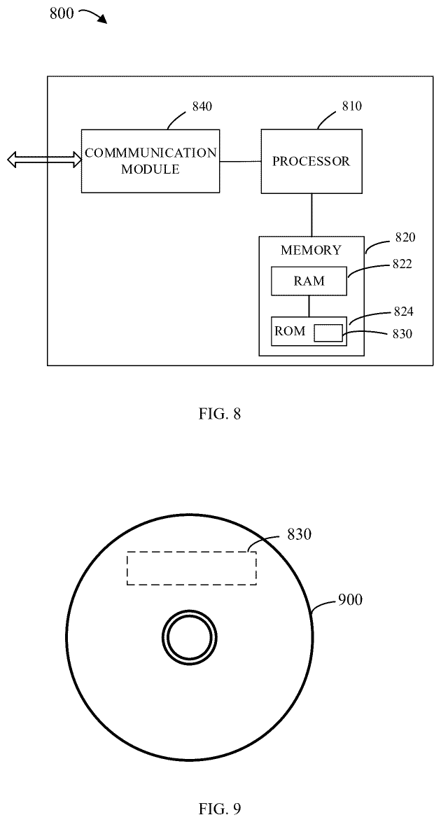

FIG. 8 illustrates an example simplified block diagram of a device 800 that is suitable for implementing embodiments of the present disclosure. The device 800 may be provided to implement a communication device or a network element, for example, the AP 104 or the non-AP STA 102 as shown in FIG. 1, the first device as shown in FIG. 2 or FIG. 4. As shown, the device 800 includes one or more processors 810, one or more memories 820 may couple to the processor 810, and one or more communication modules 840 may couple to the processor 810.

The communication module 840 is for bidirectional communications. The communication module 840 has at least one antenna to facilitate communication. The communication interface may represent any interface that is necessary for communication with other network elements, for example the communication interface may be wireless or wireline to other network elements, or software based interface for communication.

The processor 810 may be of any type suitable to the local technical network and may include one or more of the following: general purpose computers, special purpose computers, microprocessors, digital signal processors (DSPs), graphic processing units (GPUs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a read only memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program so that the device 800 may perform any process of the disclosure as discussed with reference to FIG. 1 or FIG. 7. The embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 200, 400, 600 and 700 as described above with reference to FIG. 2, FIG. 4, FIG. 6 and FIG. 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first device comprising:
at least one processor; and
at least one memory storing instructions that, when executed by the at least one processor, cause the first device at least to:
detect an overlapping basic service set (OBSS) transmission of a second device, the OBSS transmission of the second device utilizes a frequency resource substantially overlapping with a primary channel of the first device; and
determine to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces a transmitting power under the C-SR scheme.

2. The first device of claim 1, wherein the first device supports to enable the NPCA scheme and the C-SR scheme.

3. The first device of claim 1, wherein the first device is caused to determine to enable the NPCA scheme or the C-SR scheme based on at least one of the following:
a received signal strength indicator (RSSI) of an OBSS physical layer protocol data unit (PPDU) of the second device over the primary channel of the first device;
a distance between the OBSS transmission of the second device and basic service set (BSS) transmission of the first device or a distance between the first device and the second device; or
transmitting power of at least one of the first device or the second device.

4. The first device of claim 3, wherein the first device is caused to determine to enable the NPCA scheme or the C-SR scheme comprises:
determining to enable the NPCA scheme based on the RSSI of the OBSS PPDU of the second device over the primary channel of the first device being not lower than a first threshold;
determining to enable the C-SR scheme based on the RSSI of the OBSS PPDU of the second device over the primary channel of the first device being lower than a first threshold;
determining to enable the NPCA scheme based on the distance between the OBSS transmission of the second device and BSS transmission of the first device or the distance between the first device and the second device being lower than a second threshold;
determining to enable the C-SR scheme based on the distance between the OBSS transmission of the second device and BSS transmission of the first device or the distance between the first device and the second device being not lower than a second threshold;
determining to enable the NPCA scheme based on the transmitting power of the first device being not lower than a third threshold; or
determining to enable the C-SR scheme based on transmitting power of the first device being lower than a third threshold.

5. The first device of claim 4, wherein at least one of the first threshold, the second threshold or the third threshold is received from an access point (AP) via a beacon message or a probe response message.

6. The first device of claim 1, wherein one of the following is satisfied:
the first device acts as a sharing AP or a non-AP station (STA) associated with a sharing AP, and the second device acts as a shared AP or a non-AP STA associated with a shared AP; or
the first device acts as shared AP or a non-AP station (STA) associated with a shared AP, and the second device acts as sharing AP or a non-AP STA associated with a sharing AP,
wherein the sharing AP is capable of sharing a transmission opportunity (TXOP) with the shared AP.

7. The first device of claim 1, wherein one of the following is satisfied:
the first device acts as an AP, and the NPCA scheme is enabled at a non-AP STA associated with the first device when the first device determines to enable the NPCA scheme; or
the first device acts as a non-AP STA associated with an AP, and the NPCA scheme is enabled at the AP associated with the first device when the first device determines to enable the NPCA scheme.

8. The first device of claim 6, wherein the C-SR scheme is disabled at the first device and the second device when the first device or the second device determines to enable the NPCA scheme.

9. A method comprising:
detecting, by a first device, an overlapping basic service set (OBSS) transmission of a second device, the OBSS transmission of the second device utilizes a frequency resource substantially overlapping with a primary channel of the first device; and
determining, by the first device, to enable a non-primary channel access (NPCA) scheme or a coordinated spatial reuse (C-SR) scheme based on detection of the OBSS transmission of the second device, wherein the first device switches to use a NPCA primary channel instead of the primary channel under the NPCA scheme, and the first device reduces a transmitting power under the C-SR scheme.

10. The method of claim 9, wherein the first device supports to enable the NPCA scheme and the C-SR scheme.

11. The method of claim 9, wherein determining to enable the NPCA scheme or the C-SR scheme is based on at least one of the following:
a received signal strength indicator (RSSI) of an OBSS physical layer protocol data unit (PPDU) of the second device over the primary channel of the first device;
a distance between the OBSS transmission of the second device and basic service set (BSS) transmission of the first device or a distance between the first device and the second device; or
transmitting power of at least one of the first device or the second device.

12. The method of claim 11, wherein determining to enable the NPCA scheme or the C-SR scheme comprises:
determining to enable the NPCA scheme based on the RSSI of the OBSS PPDU of the second device over the primary channel of the first device being not lower than a first threshold;
determining to enable the C-SR scheme based on the RSSI of the OBSS PPDU of the second device over the primary channel of the first device being lower than a first threshold;
determining to enable the NPCA scheme based on the distance between the OBSS transmission of the second device and BSS transmission of the first device or the distance between the first device and the second device being lower than a second threshold;
determining to enable the C-SR scheme based on the distance between the OBSS transmission of the second device and BSS transmission of the first device or the distance between the first device and the second device being not lower than a second threshold;
determining to enable the NPCA scheme based on the transmitting power of the first device being not lower than a third threshold; or
determining to enable the C-SR scheme based on transmitting power of the first device being lower than a third threshold.

13. The method of claim 12, wherein at least one of the first threshold, the second threshold or the third threshold is received from an access point (AP) via a beacon message or a probe response message.

14. The method of claim 9, wherein one of the following is satisfied:
the first device acts as a sharing AP or a non-AP station (STA) associated with a sharing AP, and the second device acts as a shared AP or a non-AP STA associated with a shared AP; or
the first device acts as shared AP or a non-AP station (STA) associated with a shared AP, and the second device acts as sharing AP or a non-AP STA associated with a sharing AP,
wherein the sharing AP shares a transmission opportunity (TXOP) with the shared AP.

15. The method of claim 9, wherein one of the following is satisfied:
the first device acts as an AP, and the NPCA scheme is enabled at a non-AP STA associated with the first device when the first device determines to enable the NPCA scheme; or
the first device acts as a non-AP STA associated with an AP, and the NPCA scheme is enabled at the AP associated with the first device when the first device determines to enable the NPCA scheme.

16. The method of claim 9, wherein the C-SR scheme is disabled at the first device and the second device when the first device or the second device determines to enable the NPCA scheme.

17. A non-transitory computer readable medium comprising program instructions stored thereon for performing the method of claim 9.
